(19) United States
(12) Patent Application Publication
(10) Pub. No.: US 2016/0009001 A1
(43) Pub. Date: Jan. 14, 2016

(54) PRESSURE CASTING APPARATUS AND METHOD

(71) Applicant: PCL CERAMICS LIMITED, Norfolk (GB)

(72) Inventor: Christopher Moore, King's Lynn (GB)

(73) Assignee: PCL Ceramics Limited, Norfolk (GB)

(21) Appl. No.: 14/764,145

(22) PCT Filed: Jan. 6, 2014
(86) PCT No.: PCT/GB2014/050017

§ 371 Date: Jul. 28, 2015

(30) Foreign Application Priority Data
Jan. 29, 2013 (GB) 1301510.2

(51) Int. Cl. B28B 1/28; B28B 1/26

(52) U.S. Cl. CPC B28B 1/28; B28B 1/261; B28B 1/265

(57) ABSTRACT

The invention comprises a pressure casting machine comprising a support and a casting cell, wherein the casting cell is attached to the support such that the casting cell can, in use, be rotated, while at least a portion of the support remains stationary, the machine further comprising a releasable retainer to retain the casting call at a user-desired rotated position.

The invention also comprises a method of pressure casting comprising the steps, in this order, of filling a mould, with slip for the purpose of producing a casting when the mould is orientated at a first angle, rotating the mould so that it is orientated at a second angle; and draining the mould.

The invention is best illustrated by FIG. 1 of the diagrams.

### FIELD OF THE INVENTION

The invention relates to an apparatus and a method for pressure casting articles such as sanitaryware—including toilet bowls—in ceramic materials, In particular, the apparatus and method relate to pressure casting requiring moulds of more than two parts or cavities.

### BACKGROUND AND PRIOR ART

Pressure casting of ceramics is a well established method of the production of tableware, sanitaryware and technical ceramics, offering an effective way of turning liquid slip into an acceptably firm, moulded body, far more quickly than is possible using traditional casting methods.

This process operates thus: a preformed, microporous mould is closed using mechanical means and filled with slip or slurry. The slip/slurry is then subjected to pressure, which serves to push the water out of the slip/slurry and through the pores of the mould, leaving cast pieces of sufficient strength to support their own weight. These cast pieces are then removed from the mould, with the assistance of compressed air blown through the pores of the mould, then subsequently assembled and finished.

Pressure casting of ceramic slip requires careful control of the flow of slip in the mould cavity during the fill and drain phases of the casting process in order to optimise the drainage process and produce an acceptable product. Slip chiefly comprises three components, namely sand, which acts as a filler, glass which serves to melt, then solidify again, and a clay component, which acts to bind the materials together. Clay is an anisotropic material consisting of plate-like particles, which tend to orientate themselves in the same way when clay is in the liquid phase; however, the mixture is thixotropic and this poses challenges to the effective joining of components of the mould as a first assembly of platelike particles blocks the merging flow path of a second set of such particles; this problem is known as “slip meet”; two parts of a mould are brought together and the platelike particles of the two separate flows meet, but do not mix. Whilst it is quite possible for the user to adhere different moulded components of an article together, the user is nonetheless left with lines of weakness which can lead to cracking and aesthetic imperfection, as well as compromising durability.

During a traditional, manual casting process, it is possible to manipulate the orientation of the mould cavity and thereby to influence these flows and also to exert control over the direction of the flow of slip during the filling and drainage phases. Pressure casting machines have not traditionally been equipped so as to control the flow of slurry in this manner. A solution to this problem of no control over the orientation of the bulky, heavy pressure casting cell has been to design a moulded article such that it comprises a drainage aperture inside the mould. In toilet bowls, such an aperture is commonly known as a “button hole”; this is an aperture in the trap way which is used as a channel for water in the drainage stage, but which is plugged subsequent to drainage. Solutions such as the button hole have a number of disadvantages. First, the slip does not drain evenly, creating an uneven cast. Second, the presence of the button hole itself, even when filled, weakens the structure of the bowl. Third the process of creating and fitting button holes to bowls is time consuming and adds extra steps and therefore builds extra complexity into the bowl production process.

Nonetheless, in traditional casting, the casting phase, which is accomplished via capillary action, is relatively long and one of the chief advantages of pressure casting is the drastic reduction of this drainage phase; pressurisation is used to accelerate the dewatering process, allowing the possible number of times a mould may be used per day to increase by a considerable factor.

There is therefore a need to find a means of enhancing both the speed and the quality of drainage and mould filling in pressure casting.

It is these problems, amongst others, to which the invention attempts to provide one or more solutions.

### SUMMARY OF THE INVENTION

The invention has particular and immediate application to the production of toilet bowls, sinks and similarly large, multi-part pieces of ceramic sanitaryware and as such will be discussed at length in relation to them, but has general application to all spheres in which pressure casting is utilised.

In a first broad, independent aspect, the invention comprises a ceramic pressure casting machine comprising a support and a casting cell, wherein the casting cell is attached to the support such that the casting cell can, in use, be swung, while at least a portion of the support remains stationary, the .machine further comprising a releasable retainer to retain the casting cell at user-dictated positions within the range of its swinging movement, wherein the casting cell is partially surrounded by a C-shaped frame; and wherein the machine further comprises an overhead beam; wherein the casting cell is supported solely via attachment to the overhead beam; and said overhead beam comprises means for controlling the relative movement of the casting cell and the C-shaped frame and a sliding mechanism for opening and closing of the casting cell.
The apparatus described in the foregoing paragraph provides a means of securing the following advantages:

The machine allows the user to rotate the entire casting cell, which has never before been achieved in the field of pressure casting.

Quicker casting may be achieved, as the casting cell may be angled differently in accord with the phase of casting. Thus, during pouring and moulding, the mould may have a first orientation, which can be moved into a second orientation for drainage, and then into a third orientation for demoulding.

Thus quicker and more even drainage is facilitated.

Changes of orientation serve to militate against slip meet, by encouraging the interweaving of the different elements in the mould prior to demoulding.

Changes of orientation also serve to simplify and encourage demoulding.

By providing means of rotation it is possible to drain items via outlet channels intrinsic to the final design of the item such as the trap way in the case of toilet bowls or sinks This in turn enables greater flexibility in design, since essentially production facilitative features such as the button hole—and the stresses which they place on the integrity of the bowl—no longer need be included.

The feature of the overhead beam and its sole attachment allow for the location of the pivot, actuation means and other components of the machine to be located remotely from the casting cell itself, which reduces the exposure of those components to slip and as such increases the lifespan of the machine.

The frame serves to protect the casting cell both when it is static and particularly during rotation. The frame serves to increase the strength and integrity of the assembled casting cell.

Preferably, the support comprises a pivot and the casting cell can, in use, be rotated about the pivot.

The foregoing feature can in practice serve to allow rotation to take place about or near the centre of gravity of the casting cell, thus reducing the amount of torque generated by the movement, for example, allowing a 3.5 tonne casting cell assembly to be rotated with less than 0.5 kW. This in turn allows for more precise movement of the machine.

Preferably, the pivot comprises two pivot points, with a first pivot point being situated adjacent a first side of the casting cell and a second pivot point being situated adjacent as second, opposite side of the casting cell.

The provision of parallel pivot points provides a means of ensuring stability when swinging.

Preferably, the casting cell comprises a plurality of mould elements, wherein at least one mould element is movably mounted to the C-shaped frame and may be moved separately to the other elements of the casting cell via movement of the C-shaped frame.

The integral mould frame maintains precision of alignment after many cycles of machine operation.

Preferably, the machine comprises one casting cell only.

A standard casting machine might typically comprise casting cells or moulds with an output of eight pieces per half hour. This equipment is good for high volumes of production but can be wasteful in relation to smaller runs. The production of a single cell casting apparatus is manifestly better for smaller and one-off runs, and also provides a tool for experimenting with pressure casting—for example the testing and refinement of a new mould—where one did not exist before.

Preferably, the machine comprises at least one servo motor, wherein the rotation of the casting cell is accomplished using the servo motor.

The servo motor serves as the most appropriate means of accomplishing the rotation of the casting cell, due the precision of its movement.

Preferably, the rotation of the casting cell is automated, the machine further comprising a processor, wherein the processor controls the rotation of the casting cell and wherein the rotation of the machine is programmable via commands submitted to the processor.

The processor allows both for the execution of the pre-set moulding processes and for the programming in of new such processes; programmability is particularly useful during research and development, for example of new mould shapes.

More preferably, the machine further comprises a user interface, the user interface being in communication with the processor and wherein said user interface comprises a grid of buttons, wherein each row of the grid comprises a function of the machine and each column of the grid comprises a time value, wherein by pressing a button on the grid, the user may select or deselect the performance of a function by the machine for a given length of time.

The foregoing interface is particularly intuitive and user-friendly and has been developed to make the machine easy to use.

More preferably, the machine further comprises controls for fine adjustment of each of the functions.

Such fine tuning allows ultimately for the production of a better end-product.

The invention also comprises a pressure casting machine substantially as described herein, with reference to and as illustrated by any appropriate combination of the text and/or drawings.

In a second broad, independent aspect, the invention comprises a method of pressure casting comprising the steps, in this order, of filling a mould, with slip for the purpose of producing a casting when the mould is orientated at a first angle, rotating the mould so that it is orientated at a second angle; and draining the mould.

More preferably the invention also comprises the following subsequent steps, in this order, of rotating the mould so that it is orientated at a third angle; and removing a casting thus produced from the mould.

The above methods are facilitated by the apparatus discussed above and as such share the advantages outlined above.

The invention also comprises a method of pressure casting substantially as described herein, with reference to and as illustrated by any appropriate combination of the text and/or drawings.

### BRIEF DESCRIPTION OF THE DRAWINGS

The invention will be described in relation to the drawings, of which:

FIG. 1 is a diagrammatic side elevational view of a pressure casting machine in a first, upright position;

FIG. 2 is a diagrammatic side elevational view of a pressure casting machine in a second, swung position;

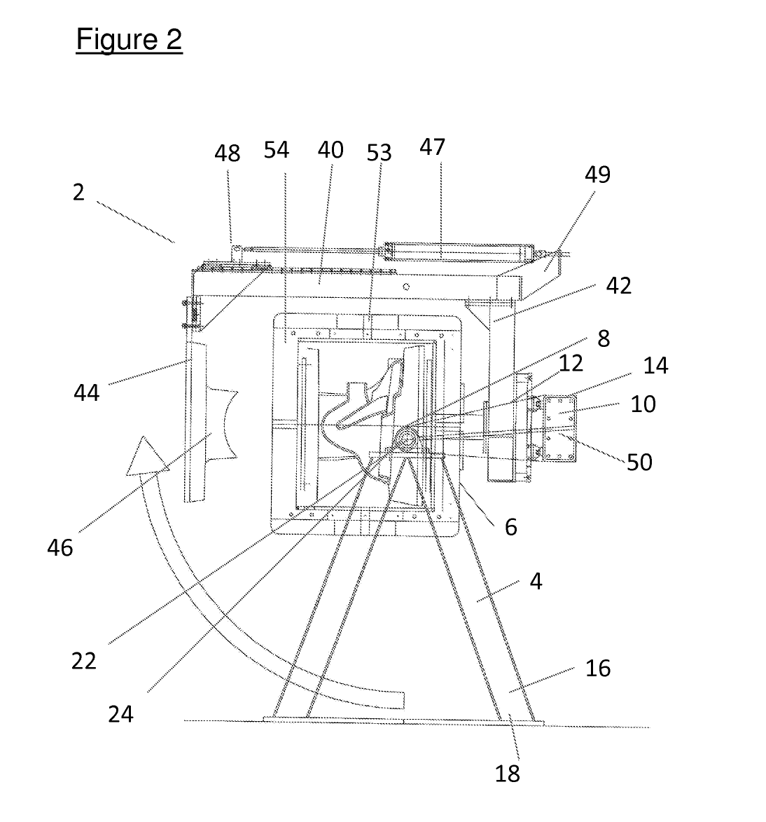

FIG. 3 is a diagrammatic side elevational view of a pressure casting machine in a third, swung position,

FIG. 4 is a diagrammatic side elevational view of a pressure casting machine in a first, upright position; and

FIG. 5 is a diagrammatic view showing an interface of the invention and the means by which it sends to commands to a pressure casting machine of the invention.

### DETAILED DESCRIPTION OF THE PREFERRED EMBODIMENTS OF THE INVENTION

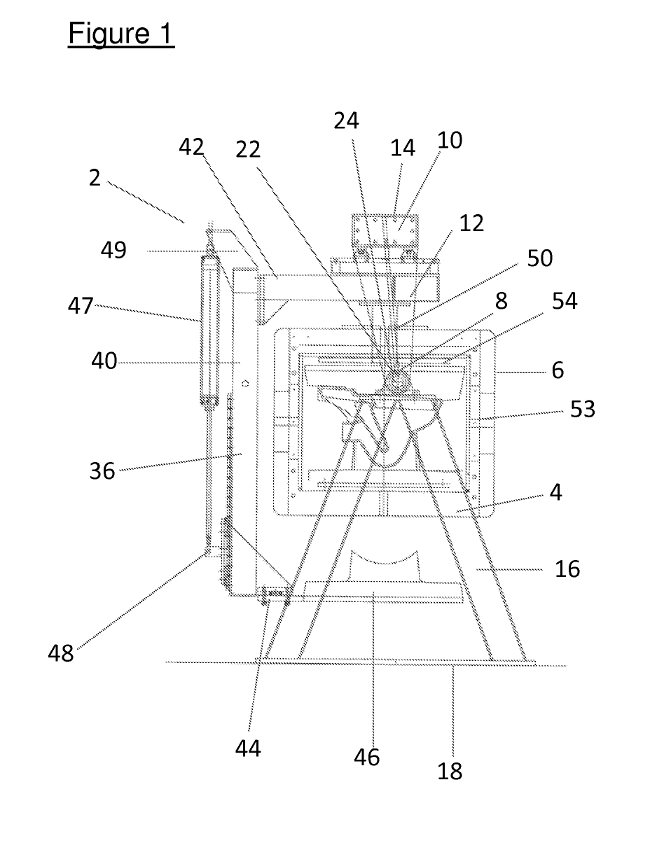

At FIG. 1, there is shown a machine, indicated generally at 2. The machine 2 comprises a support 4, a casting cell 6 and means by which the casting cell 6 can swing, pivot, tilt or rotate about the support 4, which in this case is a pivot 8, which is advantageously simple, but could be a multipart joint, a track or path or a known means by which a first part can swing, pivot, tilt or rotate relative to a second part—all of which will subsequently be referred to using the shorthand term “rotating”.

The machine 2 has particular and immediate application to the production of toilet bowls and as such will be discussed in relation to them, but has general application to all spheres in which pressure casting is utilised, including particularly sanitaryware, tableware and the technical ceramics industries. The machine 2 is composed of known materials, such as metals, alloys and plastics.

The machine 2 allows for rotation relative to one axis only, but it is possible—and within the ambit of the inventive concept—for there to be movement about several axes of rotation.

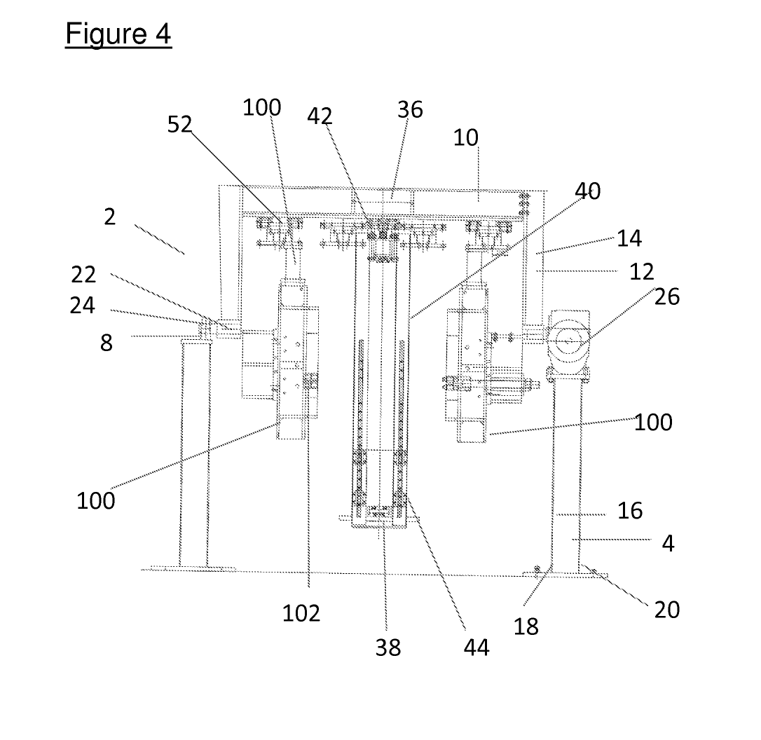

The support 4 comprises an elongate overhead beam 10, supported by two uprights 12, one at each end of the overhead beam 10. Each upright 12 comprises an upper portion 14 and a lower portion 16. The upper and lower portions 14 16 may comprise single or multiple struts—in this embodiment, the lower portions 16 bifurcate and are offset from the vertical to advantageously spread the weight of the machine 2 and ensure its stability. To further ensure the stability of the machine 2 each of the lower portions 16 engages with the ground via foot plate 18, which may be rooted into the ground with bolts 20. The lower portions 16 mark the lateral boundaries of the machine 2, with the other elements of the machine, including the upper portions 14 located notionally (i.e. between the planes running along the z axis of FIG. 4, which are co-planar with the lower portions 16) or actually between the lower portions 16. Thus, while the overhead beam 10 and the upper portions 14 rotate with the casting cell 6, the lower portions 16 remain stationary.

The in use upper extremity of each of the lower portions 16 supports pivot 8, which comprises an axle 22 held in position by a mount 24. The axle 22 provides the link between upper and lower portions 14 16. In use, each of the lower portions 16 remains static while the rest of the machine 2 pivots about pivot 8.

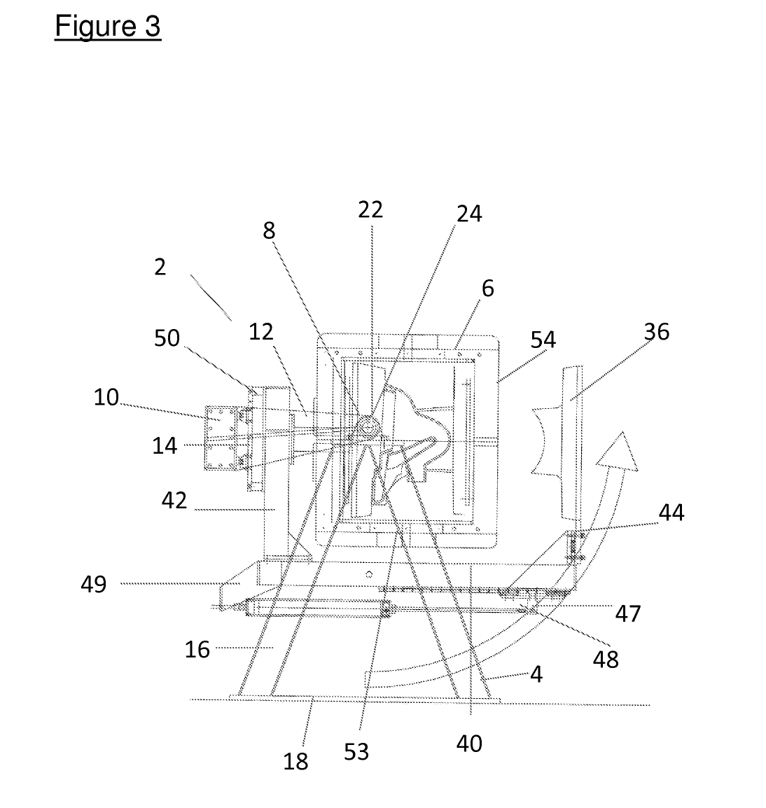

Movement of pivot 8 is achieved via a motor unit 26, preferably a servo motor, which is illustrated at FIG. 3. Other means, such as hydraulic, electric and pneumatic means may be used. Although it is quite possible for the casting cell 6 to be rotated through a full 360°, a working range for the machine 2 is +/−90° of vertical orientation. The motor unit 26 comprises the retainer, in that the motor unit 26 provides the means to retain the pivotable parts of the machine at a given angle for a desired duration as well as the means of rotating those pivotable parts between angles. Whilst the lack of movement of the motor unit 26 is a retainer as such, it may be supplemented with supplementary locking means, if that is desired.

The movement of motor unit 26 over the course of a given cycle of filling, draining and removing the moulded sections is controlled by a processor 28. In preferred embodiments, the processor 28 will have access to one or more programmes which a user may run on it. Each programme will cover a favoured filling, draining and removal sequence. The same processor 28 may serve to govern the movements of either or both of the machinery carried by the overhead beam 10 and the robotic arm (not shown), both of which have multiple key functions in the pressure casting process.

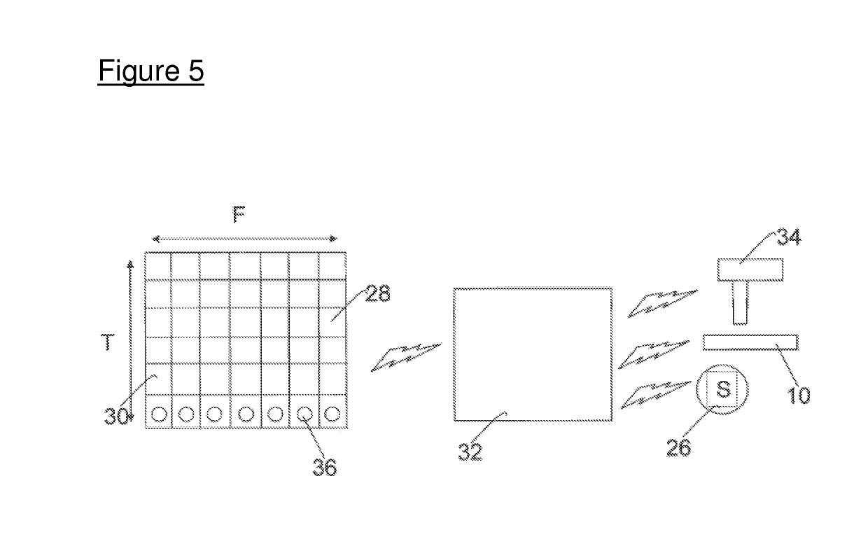

Because it is understood—particularly in relation to single casting cell embodiments of the invention—that the machine 2 will be used for short runs and more particularly for the development of new products, the machine 2 is programmable and as such is highly flexible. Standard interfaces such as a monitor responsive to commands entered via keyboard, mouse, touch-screen and other known methods can be utilised, but preferably a dedicated pegboard, as illustrated in FIG. 5 is used. The pegboard comprises a grid or matrix where preferably, each column of the grid represents a step in a given function F of the machine 2 and each row represents a given time period T of the operation of that action. The user can therefore vary the time period during which the machine 2 undertakes a given action, or turn that action off altogether through the utilisation of this “pegboard” feature, for the pegboard is in communication with the processor 32 such that it can change the commands issued by the processor and the processor 32 is in communication with elements of the machine 2, including the servo motor 26 governing rotation 26, the robot 34 and other aspects of the machine 2, including those elements mounted on the overhead beam 10. In addition trim controls 36 are designated for making small adjustments to the actions of the machine 2, in order that the user can fine tune the actions of the machine 2 or other communicating system—for example a co-operating robot (not shown)—by lower skilled operatives, while preventing damage through inexperience or lack of training, allowing for the full optimisation of the casting cycle of individual moulds. Thus the angle of rotation can be selected according to the phase of the operation of the machine 2 and there can be provided continuously variable mould inclination during the casting cycle as well as stepped movement between positions and holding of the casting cell 6 in the said rotated positions.

A C-shaped frame 38 is attached to the overhead beam 10. The C-shaped frame 38 comprises, when the machine 2 is in the upright position, an elongate column 40, an upper row 42 and a lower row 44, the rows 42 44 being perpendicularly disposed to the column. In preferred embodiments, as here, the lower row 44 is controllably movable, chiefly or solely along elongate column 40 and bears bottom or foot mould portion 46 of casting cell 6. The longitudinal movement of lower row 44 is enabled by hydraulic device 47, which runs parallel to elongate column 40 and held in place by fixtures 48 and wing 49. Bottom mould portion 46 is demountable from C shaped frame 38.

The overhead beam also comprises means 50 for controlling the relative movement of the casting cell 6 and the C-shaped frame 38 and comprises a sliding mechanism 52 for opening and closing the casting cell 6. By suspending these movement means 50 from the overhead beam, solely, as in the preferred embodiment illustrated, the build-up of dirt in the movement means 50 is avoided. In other embodiments movement means 50 may not solely be attached to or adjacent to overhead beam 10. Movement of the casting cell is also attended to by a robot (not shown) with an articulated arm of a known type. The C shaped frame 38 comprises a clamping system 53 which is of lay flat tubing and which keeps the casting cell 6 together. The clamping system 53 further comprises a tie bar ejector clamp attached between two of the mould components (not shown) which serves to pull mould components together and thus substitutes hydraulic rams, reducing significantly the size of the machine 2. The C frame 38 arrangement allows the casting cell to “float” in a stationary position, being suspended from the overhead beam only. The bottom or foot mould 46 is articulated so that it can be introduced and removed from the casting cell 6 independently of the rest of the mould components 54 which comprise the cell 6. The machine 2 can be configured to be compatible with moulds comprising different numbers of components, including 2, 3, 4, 5 and 6 part moulds.

At FIG. 4, there is shown a machine 2 without a casting cell 6; the casting cell 6 is releasably attachable to the machine 2. Here can also be seen side supports 100 which attach to casting cell 6 via attachments 102 and which aid rotation and manipulation of the casting cell 6 and its constituent parts.

Although it is possible to have multi-cellular devices, operating from a single program, the machine 2 embodied is of a single casting cell 6 design. In a similar manner to the rotation, the casting cell 6 and the mould components 54 therein may be manipulated using electrical, pneumatic or hydraulic means, or any combination of those methods including manipulation by an external robot (not shown). The mould components 54, including the bottom mould portion 46 are also held together by a pin and bush alignment system (not shown), which advantageously allow for a hard wearing mould, resistant to repeated and continuous casting.

In use, the machine is able to move between desired angles for the different phases of the casting process, namely filling, casting, drainage (which is accomplished by draining waste water and slip through a detachable trailing hose (not shown) which attaches to casting cell 6 and then demoulding.

Demoulding may be done manually, automatically or via a combination of manual and automatic aspects. An automated demoulding system may be used with one or more of the machines 2 to create a larger, automatic casting system. Fettling and further dewatering can likewise be achieved as part of an automatic process or by manual intervention.

1. A pressure casting for casting ceramic materials, comprising a support and a casting cell, wherein the casting cell is attached to the support such that the casting cell can, in use, be swung, while at least a portion of the support remains stationary, the machine further comprising a releasable retainer to retain the casting cell at user-dictated positions within the range of swinging movement of the casting cell, wherein the support comprises a C-shaped frame and the casting cell is partially surrounded by said C-shaped frame; and wherein the machine further comprises an overhead beam; wherein the casting cell is supported solely via attachment to the overhead beam; and said overhead beam comprises means for controlling the relative movement of the casting cell and the C-shaped frame and a sliding mechanism for opening and closing of the casting cell.

2. A machine according to claim 1, wherein the support comprises a pivot and the casting cell can, in use, be rotated about the pivot.

3. A pressure casting machine according to claim 2, wherein the pivot comprises two pivot points, with a first pivot point being situated adjacent a first side of the casting cell and a second pivot point being situated adjacent a second, opposite side of the casting cell.

4. A machine according to claim 1, wherein the casting cell comprises a plurality of mould elements, wherein at least one mould element is movably mounted to the C-shaped frame and may be moved separately to the other elements of the casting cell via movement of the C-shaped frame.

5. A machine according to claim 1, comprising a single casting cell only.

6. A machine according to claim 2, further comprising at least one servo motor, wherein the rotation of the casting cell is accomplished using the or each servo motor.

7. A machine according to claim 2, wherein the rotation of the casting cell is automated, the machine further comprising a processor, wherein the processor controls the rotation of the casting cell and wherein the rotation of the machine is programmable via commands submitted to the processor.

8. A machine according to claim 7, further comprising a user interface, the user interface being in communication with the processor and wherein said user interface comprises a grid of buttons, wherein each row of the grid comprises a function of the machine and each column of the grid comprises a time value, wherein by pressing a button on the grid, the user may select or deselect the performance of a function by the machine for a given length of time.

9. A machine according to claim 8, further comprising controls for fine adjustment of each of the functions.

10. (canceled)

11. A method of pressure casting using the pressure casting machine of claim 1, comprising the steps, in this order, of:
filling a casting cell with slip for the purpose of producing a casting when the casting cell is orientated at a first angle with respect to a pivot of a support of the pressure casting machine;
rotating the casting cell so that it is orientated at a second angle with respect to said pivot; and
draining the casting cell.

12. A method of pressure casting according to claim 11 comprising the further steps, in this order, of:
rotating the casting cell so that it is orientated at a third angle with respect to said pivot; and
removing a casting thus produced from the casting cell.

13. (canceled)
